(19) United States
(12) Patent Application Publication
(10) Pub. No.: US 2002/0174099 A1
(43) Pub. Date: Nov. 21, 2002

(54) Minimal identification

(76) Inventors: Anthony Raj, Santa Clara, CA (US); Prasad Krothapalli, San Jose, CA (US); Rajeev Mohindra, Santa Clara, CA (US); Amitabu Sinha, Redwood City, CA (US); Prakash Iyer, San Jose, CA (US)

Correspondence Address: PILLSBURY WINTHROP, LLP, 1600 Tysons Boulevard, McLean, VA, 22102, US

(21) Appl. No.: 09/998,010

(22) Filed: Nov. 28, 2001

Related U.S. Application Data
(60) Provisional application No. 60/253,954, filed on Nov. 28, 2000.

(51) Int. Cl. G06F 7/00

(52) U.S. Cl. 707/1

(57) ABSTRACT

A method for minimally identifying at least one component in a document. The method includes selecting a minimal signature for the at least one component that contains fewer components than a canonical signature.

This application claims the benefit of Provisional Application No. 60/253,954, filed Nov. 28, 2000.

### 1. FIELD

This invention relates to identifying information in a document, and more specifically, to identifying the information such that even if changes are made to the document the information can be relatively reliably identified and extracted.

### 2. BACKGROUND

Increasingly, wireless communications devices such as cellular phones, personal digital assistants, handheld computers provide or are being required to provide services offered by Internet based websites. Examples of services include, but are not limited to, stock trading, buying or selling goods, sports information, and the weather. The websites that provide services to wireless devices use a language, such as wireless markup language (WML) or handheld device markup language (HDML), that is typically different from the language used by websites that communicate with laptop or desktop computers. Unlike laptop or desktop computers, which have the processing power and high data rates that can typically support a browser that uses the resource demanding hypertext markup language (HTML), wireless devices often have weaker capabilities and lower data rates that support browsers (micro-browsers) that uses less demanding languages such as WML and HDML. Consequently, wireless devices often are unable to communicate with the HTML websites. Wireless device with limited resources that prevent use of HTML are referred to herein as reduced content, or ‘thin’ devices.

One way to provide the services (e.g., stock trading, weather information, directions) offered by a HTML website to a reduced content device is to create a mirror website that communicates with the reduced content device. The mirror website retrieves the HTML document(s) for the service the user of the reduced content device is interested in procuring. Since the reduced content device is unable to interpret HTML, the mirror website executes a series of instruction to produce a WML or HDML document that the reduced content device is able to interpret. The instructions indicate how information (e.g., fields of a form that needs to be completed, search request, etc. . . . ) on the HTML documents can be identified and extracted and presented to the reduced content device in the form of WML or HDML documents that the reduced content device understands. Before information is extracted it has to be identified. One way to identify information is through the assignment of a signature to the information that defines the relationship of the information to other information in the document. However, if the HTML document changes, the signature may become invalid by pointing to the wrong information. Consequently, it is desirable to provide a mechanism for generating signatures that decreases the likelihood that a signature may become invalid when the HTML document changes.

### 3. SUMMARY

A method for minimally identifying at least one component in a document is described. The method includes selecting a minimal signature for the at least one component that contains fewer components than the canonical signature.

### 4. DESCRIPTION OF THE DRAWINGS

The invention will be better understood by reference to the following detailed description and the accompanying drawing:

FIG. 1 illustrates a block diagram of a system in which wireless and wired devices communicate with an application server.

### 5. DETAILED DESCRIPTION

Methods and apparatus for providing service to a communications device that has initially contacted a service provider that is unable to provide service directly are described. In the following description, for purposes of explanation, numerous specific details are set forth in order to provide a thorough understanding of the present invention. It will be evident, however, to one skilled in the art that the present invention may be practiced in a variety of communication systems, especially wireless application protocol systems, and communications devices, especially telephones, without these specific details. In other instances, well-known operations, steps, functions and devices are not shown in order to avoid obscuring the invention.

Parts of the description will be presented using terminology commonly employed by those skilled in the art to convey the substance of their work to others skilled in the art, such as server, browser, parse tree, branch, component, structure, and so forth. Also parts of the description will also be presented in terms of operations performed through the execution of programming instructions or initiating the functionality of some electrical component(s) or circuitry, using terms such as, performing, sending, processing, transmitting, configuring, and so on. As well understood by those skilled in the art, these operations take the form of electrical or magnetic or optical signals capable of being stored, transferred, combined, and otherwise manipulated through electrical or electromechanical components.

Various operations will be described as multiple discrete steps performed in turn in a manner that is most helpful in understanding the present invention. However, the order of description should not be construed as to imply that these operations are necessarily performed in the order that they are presented, or even order dependent. Lastly, repeated usage of the phrases “in one embodiment,” “an alternative embodiment,” or an “alternate embodiment” does not necessarily refer to the same embodiment, although it may.

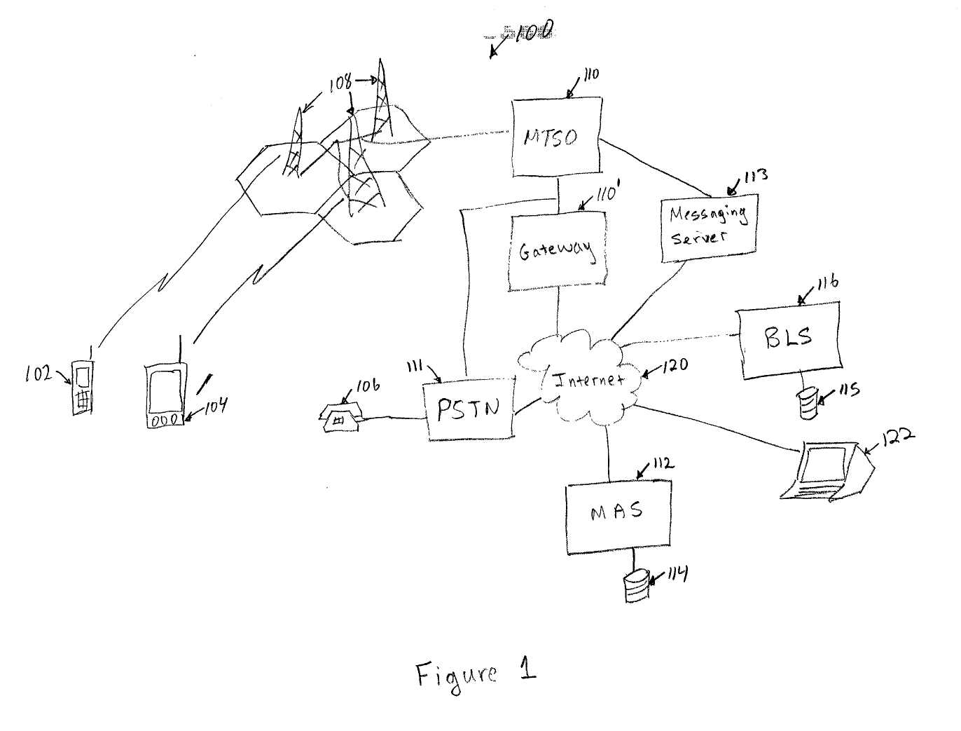

FIG. 1 illustrates a block diagram of a system in which wireless and wired devices communicate with an application server. System 100 includes telephone 102, personal digital assistant (PDA) 104, telephone 106, cellular stations 108, mobile telephone switching office 110, public switched telephone network switching office 111, mobile application server 112, storage 114, business logic server 116, storage 115, web server 118, phone server 119, internet 120, and computer 122. Business logic server 116 is the host for a website with an address or uniform resource locator that is widely known. It is not unusual for a popular website to have millions of users, if not tens of millions. For purposes of illustration, the website has the following address: www.services.com. The website provides in various embodiments services including, but not limited to, retrieving stock quotes and airline flight information or sport scores, trading stock, buying and selling goods. Since the services are provided using hypertext markup language (HTML) documents or pages, the website is referred to as a ‘full content’ website. These services can be procured directly from server 116 using computer 122 because computer 122 has sufficiently high processing power, a large display, and high communications data rate to support a web browser that is capable of executing HTML code.

Telephone 102 and PDA 104, on the other hand, typically have relatively low processing power, small displays, and a low communications data rate. Consequently, they are unable to support a browser that executes HTML code. In one embodiment, telephone 102 and PDA 104 have a browser that is capable of executing wireless markup language (WML) or handheld markup language (HDML) code, which require relatively less processing power and communications data rate, and are better suited for the small displays of telephone 102 and PDA 104. Telephone 102 and PDA 104 are referred to herein as ‘reduced content’ devices because their browsers use WML and HDML to render less graphically intensive displays. WML and HDML are referred to herein as reduced content languages.

The remaining description below is provided in the context of telephone 102 procuring service. It should be appreciated that the description is equally applicable to PDA 104, a handheld computer, or other communications devices that have user input and output interfaces and the ability to communicate with a wireless network.

The nature of the services provided by the full content website are such that they are desired by mobile users of telephone 102. Moreover, the operator of the full content website would like to service mobile users without having to change significantly the full content website. Since the full content website is typically not going to be modified and since the full content website communicates in HTML code, a user of telephone 102 cannot directly access the services of the full content website.

However, a user of telephone 102 can indirectly access the services of the full content website by using a reduced content website on server 112. Server 112 hosts a reduced content website that can take HTML documents from server 116 and reformat or represent them in a different manner so that they can be rendered on reduced content devices. Mechanisms for extracting information from an HTML document and representing it in a manner suitable for reduced content devices is the subject of co-pending patent application “Method for Converting Two-dimensional Data into a Canonical Representation” with Ser. No. 09/394,120, filed on Sep. 10, 1999, and co-pending patent application “Method for Customizing and Rendering of Selected Data Fields” with Ser. No. 09/393,133, filed on Sep. 10, 1999. Extracting information includes the process of first identifying the information.

One way to identify information in an HTML document is to provide a signature for the information. The signature is derived from a parse tree that represents the document structure from the root to the branch that contains the information. For example, in the case of HTML, information can be identified by referring to the tags that must be traversed to arrive at the information that is to be identified.

A signature is based on the hierarchical nature of information in the HTML parse tree that represents an HTML document. Information in an HTML document is contained in a tag. A tag corresponds to a component of the parse tree. A component contains zero or more other components. When a document is parsed, the containment property in the document translates into an ancestor-descendant relationship in the parse tree. If component A is the parent of component B in the parse tree, then component A “directly contains” component B. If component A directly contains component B, then component B can be characterized by a property that distinguishes it from its siblings. A property of component B that distinguishes it from its siblings is a signature of component B inside the component A. There can be one or more signatures for a component in its parent component.

A canonical signature of a component inside a document is defined by signatures of all its ancestors except the root node. For example, “body1 (fourth table(row that contains the string” everypath“))” is one way of representing the signature of a row that contains the string “everypath,” where the row is inside a fourth table that is in its parent “body1.”

An example of an HTML document in which the fourth table contains a row that contains the string “everypath” is as follows:

<!doctype html public ″-//w3c//dtd html 4.0 transitional//en″>
<html>
<head>
<title>Test</title>
</head>
<body>
<table><tr><td>First piece of text</td></tr></table>
<table><tr><td>Second piece of text</td></tr></table>
<table><tr><td>Third piece of text</td></tr></table>
<table><tr><td>Fourth piece of text containing the word every path</td>
</tr></table>
</body>
</html>

6. Document 1

The row containing the string “everypath” can be identified using its canonical signature; the canonical signature can be expressed using the following syntax:

<component type=”body”>
<component position=”4” type=”table”>

<component type=”tr” structure=”<amlvar>everypath<amlvar>”>
</component>

</component>
</component>

7. Canonical Signature

The syntax used herein is described in greater detail in co-pending patent application “Method for Converting Two-dimensional Data into a Canonical Representation” with Ser. No. 09/394,120, filed on Sep. 10, 1999.

Identifying a component by its canonical signature has the drawback that the component may not be accurately identified if the document changes. For example, an insertion or deletion before the component may cause the canonical signature to point to a component other than the one that is desired. For example, if another table is added just before table that contains the row that contains “everypath,” the table containing the row that contains “everypath” will slip to position 5. Consider the following document in which a table is inserted before the table containing the row that contains “everypath.”

<!doctype html public ″-//w3c//dtd html 4.0 transitional//en″>
<html>
<head>
<title>Test</title>
</head>
<body>
<table><tr><td>First piece of text</td></tr></table>
<table><tr><td>Second piece of text</td></tr></table>
<table><tr><td>Third piece of text</td></tr></table>
<table><tr><td>Another table inserted here</td></tr></table>
<table><tr><td>Fourth piece of text containing the word every path</td>
</tr></table>
</body>
</html>

8. Document 2

The canonical signature will first identify the body, then identify the fourth table containing the row that contains “Another table inserted here” instead of the table containing the row that contains “everypath.”. It then attempts to find the row containing the word “everypath”, but since the fourth table contains no row with the word “everypath”, the identification mechanism will report an identification failure.

A canonical signature of a component is undesirable because it may prevent extraction of the value of the component if the document changes in such a manner that the canonical signature no longer points to the desired component. Having to spend money and effort to discern the changes made in each HTML document that may be accessed and to update the signatures, if necessary, of components/information that are to be extracted is undesirable. Consequently, it is desirable to provide a mechanism for allowing components to be accurately identified and extracted without having to update the signatures. The present invention provides for such a mechanism.

To overcome the drawback of canonical signatures, the present invention provides for components to be identified with minimal signatures. Minimal signature refers to identifying the component using less components than would have been required by the canonical representation.

For document 1 given above, the string “everypath” can be minimally identified simply by specifying the row that contains “everypath.” Using the same syntax used for the canonical signature, the minimal signature for the string “everypath” is as follows:

<component type=”tr”
structure=”<amlvar>everypath<amlvar>”start=”true”>
</component>

Setting the attribute “start” to “true” indicates that a component is being identified minimally and that the HTML document should be searched for a row that contains “everypath.” It should be appreciated that with the minimal signature, unlike the canonical signature, the row containing “everypath” will be identified for both documents 1 and 2.

Minimal signatures can also be applied to identifying a set of components in a certain pattern. For example, the minimal signature for specifying all the rows having a certain characteristic “a” is as follows:

<component type=”tr”>

<idloop start=”true”>

<component type=”a”>
</component>

</idloop>
<component>

Where <idloop . . . >is a loop over components of type=“a”

A loop can also be made over structures in which text is not a child of the elements. For example, if a cell has many things separated by “br,” then everything in the cell appears as a piece of text. In that case, one can use a loop over structures as follows:

<component type”td”>

<idloop structure=”<br><amlvar>”>
</idloop>

</component>

The manner in which signatures can be generated and the generated signatures used to extract information from HTML documents is described in detail in the co-pending applications that have been incorporated herein. It should be appreciated that the methods and apparatus of these applications can also be used with minimal signatures.

While minimal identification has been described with respect to HTML documents, it should be appreciated that documents in other languages that can be parsed into tree—for example, XML—can also have components represented using a minimal signature, and the present invention encompasses minimal identification for those languages as well.

Thus, minimally identifying a component in a document and extracting the value of the component using a minimal signature has been described. Although the present invention has been described with reference to specific exemplary embodiments, it will be evident to one of ordinary skill in the art that various modifications and changes may be made to these embodiments without departing from the broader spirit and scope of the invention as set forth in the claims. Accordingly, the specification and drawings are to be regarded in an illustrative rather than a restrictive sense.

We claim:

1. A method for minimally identifying at least one component in an electronic document, the method comprising selecting a minimal signature for the at least one component that contains fewer components than a canonical signature.

2. The method of claim 1, wherein the document is in a language that can be parsed into a tree.

3. The method of claim 1, the document is an HTML document.

4. The method of claim 1, the document is an XML document.

5. The method of claim 1, wherein selecting includes specifying looping over components of a certain type.

6. The method of claim 1, wherein selecting includes specifying looping over structure.

7. A method of providing a minimal signature in an electronic document comprising the steps of:
establishing a parse tree that represents the document, the parse tree containing a plurality of components;
for each component capable of being minimally identified, providing a minimal signature that contains fewer components than a canonical signature, the minimal signature including an attribute that identifies the component as being minimally identified.

8. The method of claim 7, the document is an HTML document.

9. The method of claim 7, the document is an XML document.

10. The method of claim 7, wherein the minimal signature identifies a set of components.

11. The method of claim 10, wherein the minimal signature uses a loop over components of a certain type.

12. The method of claim 7, wherein the minimal signature uses a loop over components of a certain type.

13. The method of claim 7, further comprising the step of extracting the minimally identified component using the minimally identified signature when the attribute corresponding to the minimally identified component is set to a true state.

14. The method of claim 7, wherein the minimal signature identifies a set of components, each component within the set having a predetermined characteristic.
